(19) United States
(12) Patent Application Publication
(10) Pub. No.: US 2023/0049861 A1
(43) Pub. Date: Feb. 16, 2023

(54) BRAKE SYSTEM AND METHOD FOR BRAKING A VEHICLE HAVING AT LEAST TWO AXLES

(71) Applicant: Robert Bosch GmbH, Stuttgart (DE)

(72) Inventors: Thomas Schmidt, Bietigheim-Bissingen (DE); Toni Frenzel, Kirchheim am Neckar, (DE)

(21) Appl. No.: 17/995,505

(22) PCT Filed: Aug. 3, 2021
(86) PCT No.: PCT/EP2021/071600

§ 371 Date: Oct. 5, 2022

(30) Foreign Application Priority Data
Oct. 26, 2020 (DE) 10 2020 213 437.5

(51) Int. Cl. B60T 8/34; B60T 8/40; B60T 8/88; B60T 13/68

(52) U.S. Cl. CPC B60T 8/349; B60T 8/885; B60T 8/4081; B60T 13/686; B60T 2270/402

(57) ABSTRACT

A brake system for a vehicle having at least two axles. The brake system includes a hydraulic deceleration unit with a motorized brake pressure buildup device, a first and second wheel brake cylinder which can be mounted on a first and second wheel of a first axle of the vehicle. The first wheel brake cylinder is hydraulically connected to the motorized brake pressure buildup device via a first pressure control valve, and the second wheel brake cylinder is hydraulically connected to the motorized brake pressure buildup device via a second pressure control valve. The brake system includes an electromechanical deceleration unit having a first electromechanical wheel brake cylinder which can be mounted on a first wheel of a second axle of the vehicle and a second electromechanical wheel brake cylinder which can be mounted on a second wheel of the second axle.

### FIELD

The present invention relates to a brake system for a vehicle having at least two axles. The present invention also relates to a method for braking a vehicle having at least two axles.

### BACKGROUND INFORMATION

The related art, for example, German Patent Application No. DE 10 2016 208 529 A1, describe brake systems for vehicles having two axles, the brake systems each having exactly four wheel brake cylinders, each wheel brake cylinder being hydraulically connected at a master brake cylinder of the respective brake system to a brake pedal upstream of the master brake cylinder.

### SUMMARY

The present invention provides a brake system for a vehicle having at least two axles, and a method for braking a vehicle having at least two axles.

The present invention provides hybrid brake systems having a first “hydraulic axle” and a second “dry axle”. As will become clear from the following description, all stabilizing functions of a conventional pure hydraulic brake system, both for longitudinal stabilization and for lateral stabilization, as well as all assisted deceleration functions, can also be carried out by means of a brake system according to the present invention. Likewise, advantageous redundancies for an automated driving of the respective vehicle equipped with the brake system according to the present invention and for an automated parking of the respective vehicle, including remote controlled parking, are also realized with the brake system according to the present invention.

The second “dry axle” of the brake system according to the present invention can in particular be a central axle, the rear axle or rearmost axle of the respective vehicle having at least two axles. A conventional parking brake function is also integrable into the second “dry axle.” Another advantage of the second “dry axle” is the reduced need for toxic brake fluid in the brake system produced in this manner according to the present invention, because brake fluid is only needed for the first “hydraulic axle”, preferably the front axle or frontmost axle of the respective two-axle vehicle. Likewise, there is also no longer a need to lay brake lines to the second “dry axle” for guiding brake fluid, which significantly reduces assembly effort during assembly of the brake system according to the present invention.

In addition, the use of the first “hydraulic axle” and the second “dry axle” in the brake system according to the present invention automatically produces a variable braking force distribution for advantageously braking the respective vehicle having at least two axles, in particular if the first “hydraulic axle” is the front axle of the vehicle and the second “dry axle” is the rear axle of the vehicle. In addition, in the case of installation of at least one electric motor on the rear axle, there is the possibility of cooperation/symbiogenesis with an electric motor used for recuperative braking of the respective vehicle, while converting the kinetic energy of the vehicle into electrically storable energy. Furthermore, the brake system according to the present invention has redundancies for a reliable automated driving of the respective vehicle having at least two axles, without increasing a probability of failure of one of the components of the brake system according to the present invention, compared to related prior art.

In an advantageous embodiment of the brake system of the present invention, the hydraulic deceleration unit comprises a brake fluid reservoir to which the first wheel brake cylinder is hydraulically coupled via a first currentlessly closed outlet valve and the second wheel brake cylinder is hydraulically coupled via a second currentlessly closed outlet valve. By contrast to conventionally used check valves, the first currentlessly closed outlet valve and the second currentlessly closed outlet valve realize improved return hydraulics, in particular with a load relief in the direction of the brake fluid reservoir.

Preferably, according to an example embodiment of the present invention, the hydraulic deceleration unit comprises a master brake cylinder, to which a brake actuating element of the vehicle is connectable or connected in such a way that at least one piston of the master brake cylinder limiting at least one chamber of the master brake cylinder is adjustable by way of an actuation of the brake actuating element by a driver of the vehicle, and wherein the first wheel brake cylinder and/or the second wheel brake cylinder are hydraulically connected to the at least one chamber of the master brake cylinder via at least one currentlessly open switch valve. Thus, in the embodiment of the brake system described here, even in the event of a complete failure of all electronics of the vehicle, the driver of the vehicle still has the option of producing by his driver brake force a sufficient brake pressure in the first wheel brake cylinder and/or in the second wheel brake cylinder in order to bring the vehicle to a stop.

For example, the hydraulic deceleration unit comprises a simulator which is hydraulically connected to the at least one chamber of the master brake cylinder via a currentlessly closed switch valve. In this case, after a decoupling of the master brake cylinder from the first wheel brake cylinder and the second wheel brake cylinder, the driver can still brake into the simulator via the open switch valve, such that the driver has a standard braking feel/pedal feel despite the decoupling of the master brake cylinder.

Preferably, according to an example embodiment of the present invention, the single chamber or one of the chambers of the master brake cylinder is hydraulically connected to the brake fluid reservoir via a separator valve. This allows for a “sniffing” via the opened separator valve.

In another advantageous embodiment of the brake system of the present invention, the hydraulic deceleration unit is electrically connectable or connected to a first energy storage unit, while the electromechanical deceleration unit is electrically connectable or connected to a second energy storage unit formed separately from the first energy storage unit. In this case, if one of the two energy storage units fails, the hydraulic deceleration unit or the electromechanical deceleration unit can still be used in order to brake the vehicle. In this way, the vehicle can still be brought to a stop, in particular during autonomous driving, such as driverless driving, despite the failure of one of the two energy storage units.

According to an example embodiment of the present invention, preferably, a first control device of the hydraulic deceleration unit is designed and/or programmed in order to actuate the motorized brake pressure buildup device, the first pressure control valve, and the second pressure control valve, taking into account at least one brake specification signal output by at least one brake actuating element sensor of the vehicle, an automatic speed control of the vehicle, a second control device of the electromechanical deceleration unit, and/or a further stabilizing device of the brake system to the first control device, such that a first brake pressure present in the first wheel brake cylinder can be adjusted and modulated individually for each wheel and a second brake pressure present in the second wheel brake cylinder can be adjusted and modulated individually for each wheel. In this way, a variety of stabilization functions, such as ABS and VDC, are executable by means of the hydraulic deceleration unit.

As an advantageous further development of the present invention, the second control device of the electromechanical deceleration unit may be designed and/or programmed in order to individually actuate the first electromechanical wheel brake cylinder and the second electromechanical wheel brake cylinder, taking into account at least one further brake specification signal output by the at least one brake actuating element sensor, the automatic speed control of the vehicle, the second control device of the hydraulic deceleration unit, and/or the further stabilizing device of the brake system to the second control device. Thus, a variety of standard stabilization functions can also be executed by means of the electromechanical delay unit. In particular, by means of the electromechanical deceleration unit, wheel-individual, active deceleration modulations that may be a component of a vehicle stabilization function, for example VDC and TCS, are possible.

Preferably, according to an example embodiment of the present invention, the hydraulic deceleration unit and the electromechanical deceleration unit are linked at most to one another via at least one signal and/or bus line connected to the first control device and the second control device. It is expressly pointed out here that a link between the hydraulic deceleration unit and the electromechanical deceleration unit via hydraulic lines is not necessary. This results in a significant reduction of the cost of assembly of the brake system according to the present invention.

The advantages described above can also be produced by performing a corresponding method for braking a vehicle having at least two axles. It is expressly noted that the method for braking a vehicle having at least two axles can be further developed according to the example embodiments of the brake system discussed above.

### BRIEF DESCRIPTION OF THE DRAWINGS

Further features and advantages of the present invention are explained below with reference to the figures.

FIGS. 1A and 1B show overall and partial views of an example embodiment of the brake system according to the present invention.

FIG. 2 shows a flowchart illustrating an example embodiment of the method for braking a vehicle having at least two axles, according to the present invention.

### DETAILED DESCRIPTION OF EXAMPLE EMBODIMENTS

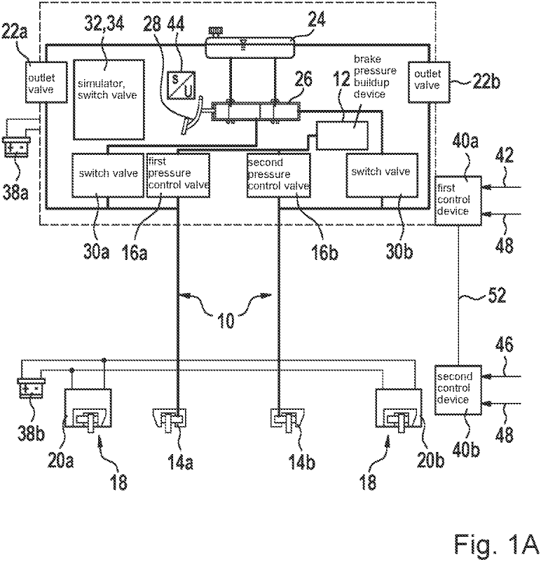

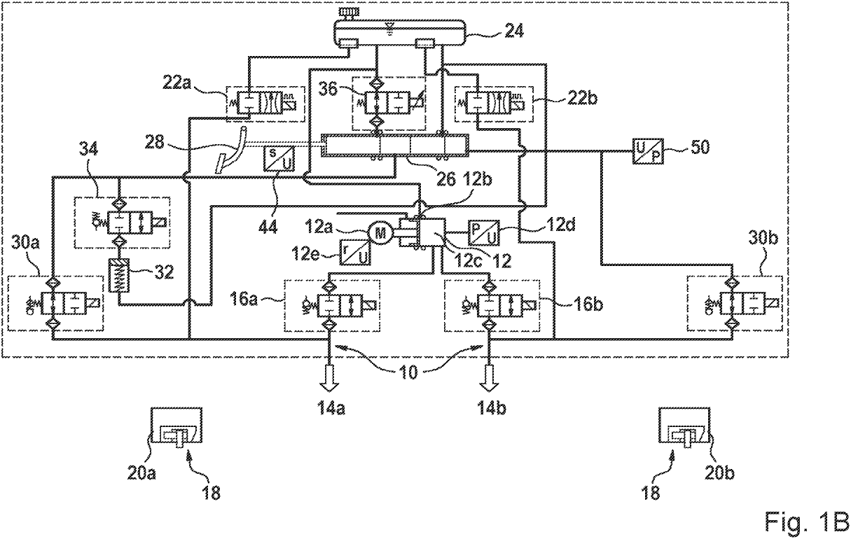

FIGS. 1A and 1B show overall and partial views of an embodiment of the brake system.

The brake system schematically depicted in FIGS. 1A and 1B can be mounted on a vehicle/motor vehicle having at least two axles. It is expressly noted that a usability of the brake system is not limited to a particular type of the vehicle/motor vehicle.

The brake system comprises a hydraulic deceleration unit 10 with at least one motorized brake pressure buildup device 12, a first wheel brake cylinder 14a which is or can be mounted on a first wheel of a first axle of the vehicle, and a second wheel brake cylinder 14b which is or can be mounted on a second wheel of the first axle. The hydraulic deceleration unit 10 can also be referred to as a decoupled power brake. Preferably, in addition to the two wheel brake cylinders 14a and 14b, the hydraulic deceleration unit 10 does not have any further wheel brake cylinders.

The first wheel brake cylinder 14a and the second wheel brake cylinder 14b can each be referred to as a “hydraulic” wheel brake cylinder that is hydraulically connected to the motorized brake pressure buildup device 12. In addition, the first wheel brake cylinder 14a is hydraulically connected to the motorized brake pressure buildup device 12 via a first pressure control valve 16a. Accordingly, the second wheel brake cylinder 14b is hydraulically connected to the motorized brake pressure buildup device 12 via a second pressure control valve 16b. Thus, a first brake pressure present in the first wheel brake cylinder 14a can be adjusted by way of the motorized brake pressure buildup device 12 with an at least partially open first pressure control valve 16a and a closed second pressure control valve 16b, independently of a second brake pressure present in the second wheel brake cylinder 14b. Accordingly, the second brake pressure in the second wheel brake cylinder 14b can also be adjusted using the motorized brake pressure buildup device 12 with an at least partially open second pressure control valve 16b and a closed first pressure control valve 16a, independently of the first brake pressure in the first wheel brake cylinder 14a. Due to the configuration of the hydraulic deceleration unit 10 with the first pressure control valve 16a and the second pressure control valve 16b, a wheel-individual brake pressure setting is thus possible for both the first wheel brake cylinder 14a and the second wheel brake cylinder 14b. Correspondingly, a wheel-individual pressure modulation is also possible for both the first brake pressure present in the first wheel brake cylinder 14a and the second brake pressure present in the second wheel brake cylinder 14b. To the extent to which a pressure difference between the first brake pressure in the first wheel brake cylinder 14a and the second brake pressure in the second wheel brake cylinder 14b is desired, the higher brake pressure can be built up using the motorized brake pressure buildup device 12, while the lower brake pressure in the respective wheel brake cylinder 14a or 14b is producible/is produced by means of a suitable delta pressure control of the associated pressure control valve 16a or 16b.

The brake system also comprises an electromechanical deceleration unit 18 having a first electromechanical wheel brake cylinder 20a which is or can be mounted on a first wheel of a second axle of the vehicle and a second electromechanical wheel brake cylinder 20b which is or can be mounted on a second wheel of the second axle. The first electromechanical wheel brake cylinder 20a and the second electromechanical wheel brake cylinder 20b can each also be referred to as an electromechanical single-wheel actuator or an electromechanical brake (EMB). Preferably, in addition to the two electromechanical wheel brake cylinders 20a and 20b, the electromechanical deceleration unit 18 does not have any further “hydraulic” wheel brake cylinders. Also, due to the configuration of the electromechanical deceleration unit 18 with first electromechanical wheel brake cylinder 20a and second electromechanical wheel brake cylinder 20b, a braking force applied to the first wheel of the second axle and the second wheel of the second axle can be adjusted or varied on a wheel-individual basis.

The first axle of the vehicle equipped with the hydraulic deceleration unit 10 can be described as a “hydraulic axle,” while the second axle of the vehicle equipped with the electromechanical deceleration unit 18 can be called a “dry axle.” Typical stabilization functions, such as ABS (antiblocking system) and VDC (vehicle dynamic control), can be implemented on the “hydraulic axle.” ABS modulations (electromechanical brake modulations) in particular can be easily implemented on the “dry axle.”

Preferably, the first axle of the vehicle is its front axle, or frontmost axle, while the second axle of the vehicle is a center axle, its rear axle, or its rearmost axle. The first wheel of the first axle and the second wheel of the first axle can thus be front wheels of the vehicle, while the first wheel of the second axle and the second wheel of the second axle can be understood to mean its rear wheels. The allocation of the hydraulic deceleration unit 10 to the front axle or the frontmost axle of the vehicle and the electromechanical deceleration unit 18 to the center axle and/or the rear axle or the rearmost axle of the vehicle takes into account the fact that, for a braking of the rear wheels of the vehicle, often a lower force/clamping force, a smaller dynamic response, and a lower setting accuracy is sufficient in comparison to a braking of the front wheels. Thus, the electromechanical deceleration unit 18 can produce reliable braking of the rear wheels, while the advantages/strengths of the hydraulic deceleration unit 10 compared to the electromechanical deceleration unit 18 for the front wheels can be utilized. Again, it is noted here that the advantages of the hydraulic deceleration unit 10 compared to the electromechanical deceleration unit 18 lie in a higher dynamics and in an increase in the applicable force. Since, due to dynamic axle load distributions, higher dynamics and a greater applicable force is normally desired on the front wheels compared to the rear wheels, the use of the hydraulic deceleration unit 10 is beneficial specifically for the front wheels. For the rear wheels, the more cost-efficiently manufactured electromechanical deceleration unit 18 can instead be used. At the same time, by equipping the brake system with the electromechanical deceleration unit 18, its need for toxic brake fluid is significantly reduced compared to the prior art.

The allocation of the hydraulic deceleration unit 10 to the front axle or frontmost axle of the vehicle and of the electromechanical deceleration unit 18 to the center axle, the rear axle and/or rearmost axle of the vehicle also automatically produces a variable braking force distribution between front and rear wheels, which provides a stable braking of the respective vehicle. Because the function of the parking brake is typically integrated into the rear wheel actuators in the prior art, in the brake system schematically shown by FIGS. 1A and 1B, the function of the parking brake is or can be easily integrated into the electromechanical deceleration unit 18.

Additionally, electromechanical deceleration unit 18 can cooperate well with an electric motor utilized in order to recuperatively decelerate the particular vehicle, while converting the kinetic energy of the vehicle into electrically storable energy. In particular, there are possibilities for cooperation/symbiogenesis such that, when the electric motor is not usable for recuperative braking of the vehicle, this can easily be compensated by means of an appropriately adjusted operation of the electromechanical deceleration unit 18. Thus, in the event that the electric motor is not usable for recuperative braking of the vehicle, it is often not necessary to respond with a complex “hydraulic blending process” of the hydraulic deceleration unit 10, i.e., with a variation of the first brake pressure in the first wheel brake cylinder 14a and/or the second brake pressure in the second wheel brake cylinder 14b. Instead, by appropriately controlling the first electromechanical wheel brake cylinder 20a and/or the second electromechanical wheel brake cylinder 20b, an absent usability of the electric motor for recuperative braking of the vehicle can be easily compensated. In addition, recuperation in the vehicle equipped with the brake system is possible without limitations of a recuperation efficiency or affecting a brake actuation feeling/pedal feeling.

Another advantage of the brake system schematically illustrated in FIGS. 1A and 1B is the hydraulic connection of the first wheel brake cylinder 14a via a first currentlessly closed outlet valve 22a to a brake fluid reservoir 24 of hydraulic deceleration unit 10 and the hydraulic connection of the second wheel brake cylinder 14b via a second currentlessly closed outlet valve 22b to the brake fluid reservoir 24. Thus, it is possible at any time to reduce on a wheel-individual basis the first brake pressure in the first wheel brake cylinder 14a via an opening of the first currentlessly closed outlet valve 22a and the second brake pressure in the second wheel brake cylinder 14b via an opening of the second currentlessly closed outlet valve 22b. The first currentlessly closed outlet valve 22a and second currentlessly closed outlet valve 22b, along with the first pressure control valve 16a and the second pressure control valve 16b, can be utilized in order to modulate the first brake pressure in the first wheel brake cylinder 14a or the second brake pressure in the second wheel brake cylinder 14b, for example to perform an ABS function or a VDC function. If desired, a pressure difference between the first brake pressure in the first wheel brake cylinder 14a and the second brake pressure in the second wheel brake cylinder 14b can also be adjusted by means of the first pressure control valve 16a, the second pressure control valve 16b, the first currentlessly closed outlet valve 22a, and/or by means of the second currentlessly closed outlet valve 22b.

As an advantageous further development, the hydraulic deceleration unit 10 of the brake system of FIGS. 1A and 1B also comprises a master brake cylinder 26, to which a brake actuating element 28 of the vehicle is connectable or connected in such a way that at least one piston of the master brake cylinder 26 limiting at least one chamber of the master brake cylinder 26 is or can be adjusted by way of an actuation of the brake actuating element 28 by a driver of the vehicle. The brake actuating element 28 can be, for example, a brake pedal. The first wheel brake cylinder 14a and/or the second wheel brake cylinder 14b are hydraulically connected to the at least one chamber of the master brake cylinder 26 via at least one currentlessly open switch valve 30a and 30b. By way of example, in the brake system of FIGS. 1A and 1B, the first wheel brake cylinder 14a is hydraulically connected to a first chamber of the master brake cylinder 26 via a first currentlessly open switch valve 30a and the second wheel brake cylinder 14b is hydraulically connected to a second chamber of the master brake cylinder 26 via a second currentlessly open switch valve 30b. Thus, by opening at least one of the currentlessly open switch valves 30a and 30b, it can be ensured that the driver operating the brake actuating element 28 can still brake into the first wheel brake cylinder 14a and/or the second wheel brake cylinder 14b by means of his or her driver braking force in order to cause an increase in the brake pressure in the first wheel brake cylinder 14a and/or in the second wheel brake cylinder 14b. In this way, even during a complete electronic failure of his/her vehicle, the driver can safely bring the vehicle to a stop by means of the effected increase in brake pressure. In addition, due to the equipping of the brake system of FIGS. 1A and 1B with the two currentlessly open switch valves 30a and 30b, the first brake pressure present in the first wheel brake cylinder 14a and the second brake pressure present in the second wheel brake cylinder 14b can be adjusted on a wheel-individual basis to be less than or equal to a master brake cylinder pressure present in the master brake cylinder 26. It is noted, however, that due to the redundancies of the brake system described below, equipping it with the master brake cylinder 26 is generally not necessary. The hydraulic deceleration unit 10 can therefore also be a master brake cylinder-less hydraulic deceleration unit 10.

A further advantageous development of the brake system of FIGS. 1A and 1B is a simulator 32 of the hydraulic deceleration unit 10, which is hydraulically connected to the at least one chamber of the master brake cylinder 26 via a currentlessly closed switch valve 34. Provided that the at least one currentlessly open switch valve 30a and 30b, via which the first wheel brake cylinder 14a and/or the second wheel brake cylinder 14b are connected to the at least one chamber of the master brake cylinder 26, is in its closed state, it can be ensured via an opening of the currentlessly closed switch valve 34 that the driver operating the brake actuating element 28 brakes into the simulator 32 via the currentlessly closed switch valve 34, and therefore, despite the decoupling of the first wheel brake cylinder 14a and the second wheel brake cylinder 14b via the at least one currentlessly open switch valve 30a and 30b, which is present in its closed state, the driver still has a standard brake actuation feel/pedal feel.

During normal operation of the brake system, the at least one currentlessly open switch valve 30a and 30b, via which the first wheel brake cylinder 14a and/or the second wheel brake cylinder 14b are connected to the at least one chamber of the master brake cylinder 26, is closed and the driver brakes via the currentlessly closed switch valve 34, which is present in its open state, into the simulator 32. In normal operation of the brake system, when outlet valves 22a and 22b are closed, the pressure control valves 16a and 16b, which are present in their open state, can be used in order to set the respectively desired brake pressure in first wheel brake cylinder 14a and second wheel brake cylinder 14b.

A reference chamber of the simulator 32, which is located on a side of a piston of the simulator 32 facing away from the currentlessly closed switch valve 34, can be hydraulically connected to the brake fluid reservoir 24, as shown schematically in FIG. 1B. Likewise, the single chamber or one of the chambers of the master brake cylinder 26 can be hydraulically connected to the brake fluid reservoir 24 via a separator valve 36, preferably a currentlessly open separator valve 36. If present, the separator valve 36 can be advantageously employed for “sniffing.”

Merely by way of example, in the brake system of FIGS. 1A and 1B, the motorized brake pressure buildup device 12 is configured as a piston-cylinder device 12 or as a plunger device. For this purpose, the motorized brake pressure buildup device 12 comprises, by way of a motor 12a, a linearly adjustable piston 12b, wherein brake fluid is transferable between a storage volume 12c of the motorized brake pressure buildup device 12 and at least one of the wheel brake cylinders 14a and 14b via an adjustment of the linearly adjustable piston 12b. As an optional further development, the motorized brake pressure buildup device 12 additionally comprises a connected pressure sensor 12d and a rotation rate sensor 12e of the motor 12a. A reference chamber formed on a side of piston 12b facing away from storage volume 12c can also be hydraulically connected to the brake fluid reservoir 24, which is however not schematically shown in FIG. 1B. It is noted, however, that the configuration of the motorized brake pressure buildup device 12 as a piston-cylinder device 12 is merely to be interpreted as an example. Alternatively, for example, at least one pump can also be used as a motorized brake pressure buildup device 12.

As can be seen in FIG. 1A, in the brake system described herein, the hydraulic deceleration unit 10 is electrically connectable or connected to a first energy storage unit 38a, while the electromechanical deceleration unit 18 is electrically connectable or connected to a second energy storage unit 38b formed separately from the first energy storage unit 38b. For example, the first energy storage unit 38a and/or the second energy storage unit 38b can each be a battery. The separate configuration of the two energy storage units 38a and 38b is understood to mean that, even after a failure of one of the two energy storage units 38a and 38b, the other energy storage unit 38a and 38b can normally still output energy. The failure of the one of the two energy storage units 38a and 38b can thus normally still be bridged by means of the other of the two energy storage units 38a and 38b, because in such a situation at least the hydraulic deceleration unit 10 or the electromechanical deceleration unit 18 can perform its function in such a way that the vehicle is reliably braked.

Preferably, the brake system comprises at least a first control device 40a, by means of which at least the motorized brake pressure buildup device 12, the first pressure control valve 16a, and the second pressure control valve 16b, and possibly at least one further component of the hydraulic deceleration unit 10, are actuated or actuatable. Optionally, the first control device 40a can also be designed and/or programmed in order to actuate the first electromechanical wheel brake cylinder 20a and the second electromechanical wheel brake cylinder 20b. Preferably, however, in addition to the first control device 40a of the hydraulic deceleration unit 10, the brake system also comprises a second control device 40b of the electromechanical deceleration unit 18, which device is designed and/or programmed in order to actuate the first electromechanical wheel brake cylinder 20a and the second electromechanical wheel brake cylinder 20b. Due to the equipping of the brake system with the two control devices 40a and 40b, it can be ensured that, in the event of a failure of one of the two control devices 40a and 40b, at least the hydraulic deceleration unit 10 or the electromechanical deceleration unit 18 can perform its function such that the vehicle can be reliably brought to a stop.

The brake system of FIGS. 1A and 1B has a high degree of redundancy due to the two energy storage units 38a and 38b and the two control devices 40a and 40b, for which reason the brake system is in particular well-suited for a vehicle designed/programmed for automated driving. The brake system can therefore be well used in particular for assisted, automated, and semi-automated applications or for purely manual driving.

Preferably, at least the motorized brake pressure buildup device 12, the first pressure control valve 16a, and the second pressure control valve 16b, and possibly at least one further component of the hydraulic deceleration unit 10, are actuatable by means of the first control device 40a, such that the first brake pressure present in the first wheel brake cylinder 14a and the second brake pressure present in the second wheel brake cylinder 14b are adjustable and modulatable on a wheel-individual basis. Preferably, the second control device is also designed and/or programmed in order to individually actuate the first electromechanical wheel brake cylinder 20a and the second electromechanical wheel brake cylinder 20b. Further functions, such as TCS (Traction Control System) and VDC (Vehicle Dynamic Control), can also be implemented by means of the hydraulic deceleration unit 10 and/or the electromechanical deceleration unit 18.

The first control device 40a of the hydraulic deceleration unit 10 can in particular be designed and/or programmed in order to actuate at least the motorized brake pressure buildup device 12, first pressure control valve 16a, and second pressure control valve 16b, and possibly at least one further component of the hydraulic deceleration unit 10, taking into account at least one braking specification signal 42 output by at least one brake actuating element sensor 44 of the vehicle, an automatic speed control (not shown) of the vehicle, the second control device 40b of the electromechanical deceleration unit 18, and/or a further stabilizing device (not shown) of the brake system to the first control device 40a. For example, the at least one brake actuating element sensor 44 can be a rod path sensor and/or a differential path sensor. The automatic speed control can be, for example, an intelligent cruise control, specifically an ACC device (Adaptive Cruise Control), or an emergency braking device, such as in particular an AEB device (Autonomous Emergency Braking). The second control device 40b of the electromechanical deceleration unit 18 can also be configured and/or programmed in order to actuate the first electromechanical wheel brake cylinder 20a and the second electromechanical wheel brake cylinder 20b, taking into account at least one further brake specification signal 46 output by the at least one brake actuating element sensor 44, the automatic speed control of the vehicle, the first control device 40a of the hydraulic deceleration unit 10, and/or the further stabilizing device of the brake system to the second control device 40b. Also, at least one pressure signal 48 of at least one pressure sensor 12d and 50 can be considered during the actuation by means of first control device 40a and/or the second control device 40b.

Preferably, the hydraulic deceleration unit 10 and the electromechanical deceleration unit 18 are linked at most to one another via at least one signal and/or bus line 52 connected to the first control device 40a and the second control device 40b. It is expressly noted here that, in the brake system of FIGS. 1A and 1B, no “hydraulic connection” through brake lines is needed between the hydraulic deceleration unit 10 and the electromechanical deceleration unit 18. Thus, there is also no conventional assembly effort for laying such conventionally required brake lines between the first axle of the hydraulic deceleration unit 10 and the second axle of the electromechanical deceleration unit 18. Similarly, the brake system of FIGS. 1A and 1B requires comparatively little toxic brake fluid. Nevertheless, a significant component reduction and complexity reduction is realized in the brake system, which significantly reduces its manufacturing costs. In addition, due to the modularity of the brake system, different embodiment variants can be cost-effectively implemented.

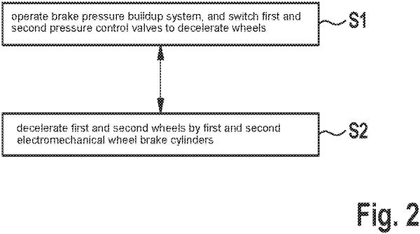

FIG. 2 shows a flowchart illustrating an embodiment of the method for braking a vehicle having at least two axles.

The method discussed below can be performed on (nearly) any vehicle having at least two axles. It is expressly noted that a feasibility of the method is not limited to a particular type of the (motor) vehicle.

In a method step S1 of the method, a motorized brake pressure buildup device of a hydraulic deceleration unit is operated, and a first pressure control valve, via which a first wheel brake cylinder of the hydraulic deceleration unit mounted on a first wheel of a first axle of the vehicle is hydraulically connected to the motorized brake pressure buildup device, and a second pressure control valve, via which a second wheel brake cylinder of the hydraulic deceleration unit mounted on a second wheel of the first axle is hydraulically connected to the motorized brake pressure buildup device, are switched in such a way that the first wheel is decelerated by means of the first wheel brake cylinder and the second wheel is decelerated by means of the second wheel brake cylinder.

In a further method step S2, a first wheel of a second axle of the vehicle is decelerated by means of a first electromechanical wheel brake cylinder of an electromechanical deceleration unit mounted thereon and a second wheel of the second axle is decelerated by means of a second electromechanical wheel brake cylinder of the electromechanical deceleration unit mounted thereon. Thus, an execution of the method described herein also provides the advantages discussed above.

The method steps S1 and S2 can be carried out in any order, simultaneously or overlapping in time. In addition to the method steps S1 and S2, the method can also be expanded by the processes explained above.

1-10. (canceled)

11. A brake system for a vehicle having at least two axles, comprising:
a hydraulic deceleration unit with a motorized brake pressure buildup device, a first wheel brake cylinder which is configured to be mounted on a first wheel of a first axle of the vehicle, and a second wheel brake cylinder which is configured to be mounted on a second wheel of the first axle, wherein the first wheel brake cylinder is hydraulically connected to the motorized brake pressure buildup device via a first pressure control valve, and the second wheel brake cylinder is hydraulically connected to the motorized brake pressure buildup device via a second pressure control valve; and
an electromechanical deceleration unit having a first electromechanical wheel brake cylinder which is configured to be mounted on a first wheel of a second axle of the vehicle, and a second electromechanical wheel brake cylinder which is configured to be mounted on a second wheel of the second axle.

12. The brake system according to claim 11, wherein the hydraulic deceleration unit includes a brake fluid reservoir to which the first wheel brake cylinder is hydraulically coupled via a first currentlessly closed outlet valve and the second wheel brake cylinder is hydraulically coupled via a second currentlessly closed outlet valve.

13. The brake system according to claim 11, wherein the hydraulic deceleration unit includes a master brake cylinder, to which a brake actuating element of the vehicle is connectable or connected in such a way that at least one piston of the master brake cylinder limiting at least one chamber of the master brake cylinder is adjustable by way of an actuation of the brake actuating element by a driver of the vehicle, and wherein the first wheel brake cylinder and/or the second wheel brake cylinder are hydraulically connected to the at least one chamber of the master brake cylinder via at least one currentlessly open switch valve.

14. The brake system according to claim 13, wherein the hydraulic deceleration unit includes a simulator which is hydraulically connected to the at least one chamber of the master brake cylinder via a currentlessly closed switch valve.

15. The brake system according to claim 13, wherein the at least one chamber of the master brake cylinder is hydraulically connected to a brake fluid reservoir via a separator valve.

16. The brake system according to claim 11, wherein the hydraulic deceleration unit is electrically connectable or connected to a first energy storage unit, and wherein the electromechanical deceleration unit is electrically connectable or connected to a second energy storage unit formed separately from the first energy storage unit.

17. The brake system according to claim 11, wherein a first control device of the hydraulic deceleration unit is configured to actuate the motorized brake pressure buildup device, the first pressure control valve, and the second pressure control valve, taking into account at least one brake specification signal output by at least one brake actuating element sensor of the vehicle and/or an automatic speed control of the vehicle and/or a second control device of the electromechanical deceleration unit and/or a further stabilizing device of the brake system to the first control device, such that a first brake pressure present in the first wheel brake cylinder can be adjusted and modulated individually for each wheel and a second brake pressure present in the second wheel brake cylinder can be adjusted and modulated individually for each wheel.

18. The brake system according to claim 17, wherein the second control device of the electromechanical deceleration unit is configured to individually actuate the first electromechanical wheel brake cylinder and the second electromechanical wheel brake cylinder, taking into account at least one further brake specification signal output by the at least one brake actuating element sensor and/or the automatic speed control of the vehicle and/or the first control device of the hydraulic deceleration unit and/or the further stabilizing device of the brake system, to the second control device.

19. The brake system according to claim 17, wherein the hydraulic deceleration unit and the electromechanical deceleration unit are linked at most to one another via at least one signal and/or bus line connected to the first control device and the second control device.

20. A method for braking a vehicle having at least two axles, comprising the following steps:
operating a motorized brake pressure buildup device of a hydraulic deceleration unit and switching a first pressure control valve, via which a first wheel brake cylinder of the hydraulic deceleration unit mounted on a first wheel of a first axle of the vehicle is hydraulically connected to the motorized brake pressure buildup device, and a second pressure control valve, via which a second wheel brake cylinder of the hydraulic deceleration unit mounted on a second wheel of the first axle is hydraulically connected to the motorized brake pressure buildup device in such a way that the first wheel is decelerated by means of the first wheel brake cylinder and the second wheel is decelerated by means of the second wheel brake cylinder; and
braking a first wheel of a second axle of the vehicle by means of a first electromechanical wheel brake cylinder of an electromechanical deceleration unit mounted thereon and a second wheel of the second axle by means of a second electromechanical wheel brake cylinder of the electromechanical deceleration unit mounted thereon.
